(19) United States
(12) Patent Application Publication
(10) Pub. No.: US 2013/0339217 A1
(43) Pub. Date: Dec. 19, 2013

(54) Real-Time Automated Online Loan Transaction System

(71) Applicant: On Deck Capital, Inc., New York, NY (US)

(72) Inventors: Noah Breslow, New York, NY (US); Alfie Umbhau, New York, NY (US); Neal Connolly, New York, NY (US); Dario Vergara, New York, NY (US); Jorge Sun, New York, NY (US)

(73) Assignee: On Deck Capital, Inc., New York, NY (US)

(21) Appl. No.: 13/903,384

(22) Filed: May 28, 2013

Related U.S. Application Data
(60) Provisional application No. 61/651,679, filed on May 25, 2012.

(51) Int. Cl. G06Q 40/02

(52) U.S. Cl. CPC G06Q 40/025
USPC 705/38

(57) ABSTRACT

The disclosure relates to a real-time online loan application, underwriting, loan design and loan boarding system and method for conducting such transactions online. The system can be user self-served real time and immediate with complete automation from the lender perspective. The disclosure is directed toward loan transactions for small businesses.

### CROSS-REFERENCE TO RELATED APPLICATION

This application claims priority to U.S. Provisional Application No. 61/651,679 filed on May 25, 2012, the entirety of which is hereby incorporated by reference.

### FIELD OF THE INVENTION

The disclosed embodiments relate generally to a real-time online loan application, underwriting, loan design and loan boarding system and method for conducting such transactions online.

### BACKGROUND

Traditionally, financial products, such as loans, have been marketed largely through financial institutions' literature and agents. The financial service provider relies on the agents for a large number of tasks, including acquiring demographic information, verifying the accuracy of the information, evaluating the information, and offering to sell products to the customer.

Technology has changed the landscape of the financial services industry such that agents play an increasingly shrinking role in marketing the financial products to potential borrowers. As the Internet has grown in popularity, potential borrowers shop for financial services over the Internet without the aid of an agent. A growing number of online companies also provide loan services; however, these online companies currently fall short of fully automating the loan process. In the case of financial institutions, potential borrowers can apply for loans or other financial services online; however, the loan approval process still requires the involvement of an agent. Third party providers of financial services can provide a list of available financial services based on criteria provided by the potential borrower, but the potential borrower must still contact the financial services agency directly or await a contact by an agent of the financial services agency.

A large percentage of these potential borrowers are the owners of small businesses. Small businesses encounter a number of unique challenges when trying to secure financing. The lack of a cost-effective infrastructure to efficiently analyze small businesses has forced financial institutions to rely on an inaccurate shortcut: The personal credit score of the owner. It is a fast and inexpensive way to make a judgment. However, it reflects the personal payment history of an individual, not the current financial state of the business. While this piece of data is easy to procure, it is a highly inaccurate indicator of creditworthiness. The problem in relying on the personal credit score becomes especially pronounced because many small business owners use personal credit to initially build their businesses, which creates a roadblock to accessing capital once they've become more established.

The process is also inefficient for small business owners. Completing lengthy loan packages from traditional lenders is a labor intensive process, requires detailed paperwork and can take weeks before they receive a decision, let alone capital. The lending space has been slow to adapt new methods to improve service and turnaround time. In addition to relying on information other than personal credit score and reducing loan processing time, the present invention also provides a critically needed mechanism for commercial institutions to efficiently reach and serve the historically underserved Main Street small business market. The present invention implements technology which will allow both small business and lenders to benefit.

### SUMMARY

The present invention addresses the needs of small businesses by creating a platform which makes capital available faster and easier than any other option on the market. Utilizing the present invention, the approval process that often takes weeks or even months, can now take just minutes, all done entirely online.

Obtaining a loan using the present invention is fast, simple, and transparent for small business owners. The present invention uses data aggregation and electronic payment technology to evaluate the financial health of small businesses and to efficiently deliver capital to a market underserved by traditional bank loans. Business owners set up their online profile and immediately get free insights into their credit profile and cash position. The loan application and approval process is completely automated, and once approved the business owner is empowered to select from available term and loan options that best meet their business needs. From there, the funding process enables the funds to be deposited very quickly. This is a significant advancement for a process that has historically taken many weeks and required a major investment of time and extensive documentation from business owners.

Embodiments of the present invention include methods for transacting a monetary loan online for a business comprising: receiving loan application information via a network from a borrower's computing system; obtaining business, credit, and bank data and, optionally, firmographic and/or social data for said borrower via a network using said loan application information; making an underwriting decision and an available loan terms decision based on the business, credit and bank data and optionally, firmographic and/or social data; displaying on said borrower's computing system via a network said underwriting decision and a list of said available loan terms; obtaining selected loan terms and an electronic loan signature from said borrower's computing system via a network; and providing loan funding according to said selected loan terms to said borrower via a network; wherein each of these steps are automated. Some embodiments involve performing a fraud check prior to obtaining business, credit, and bank data for said borrower. In other embodiments, a risk assessment score is determined after obtaining data for said borrower. Additional embodiments include the step of verifying the borrower and business identity via a network prior to displaying on said borrower's computing system said underwriting decision and a list of said available loan terms.

### BRIEF DESCRIPTION OF DRAWINGS

The invention is described in detail below with reference to the appended drawings, wherein like numerals designate similar parts.

FIG. 1 is a flow chart diagram of one example of a loan process.

FIG. 2 is an example of a landing page for obtaining a loan.

FIG. 3 is an example of an initial information entry page for a borrower.

FIG. 4 is an example of a loan information entry page.

FIG. 5 is an example of a loan information entry page.

FIG. 6a is an example of a loan information entry page.

FIG. 6b is an example of a loan information entry page.

FIG. 6c is an example of a loan information entry page.

FIG. 7 is an example of a loan feedback display page.

FIG. 8 is an example of a customizable loan interface page.

FIG. 9 is an example of a closing documents submission page.

FIG. 10 is an example of a funding information page.

FIG. 11 is an example of an identity verification page.

FIG. 12 is an example of an identity verification page.

FIG. 13 is an example of an e-signature page.

### DETAILED DESCRIPTION

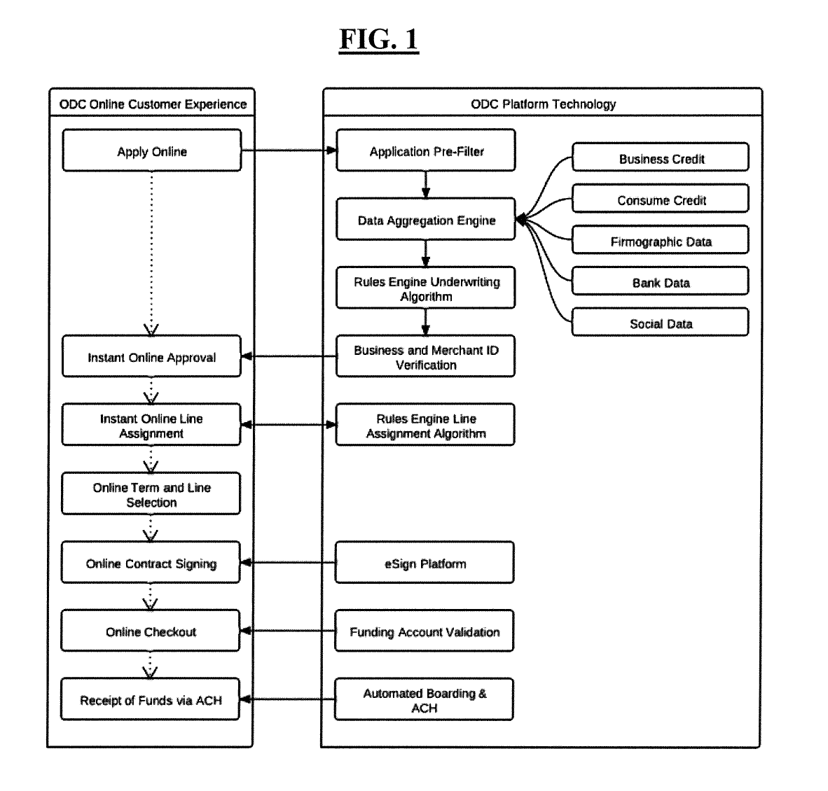

The present invention relates to a real-time online loan application, underwriting, loan design and loan boarding system and method for conducting such transactions online. The system comprises a platform capable of data aggregation and making electronic payments, which includes a user interface to allow a potential borrower to set up a merchant profile. Each step in the process for conducting the loan transaction occurs in real-time between at least two computer system, for example a borrower's computer system and a lender's computer system, over a network, such as the Internet. FIG. 1 shows a flow chart of one embodiment of the loan process of the present invention from both the perspective of a borrower's computer system and a lender's computer system or platform technology. An example of the process is described below.

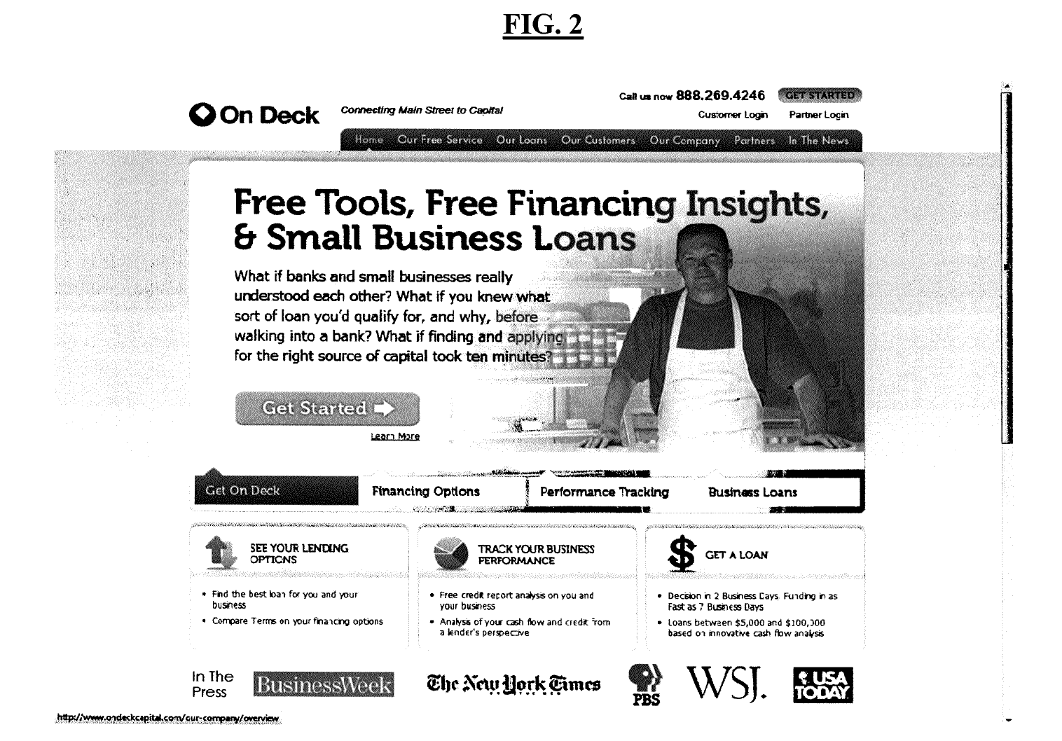

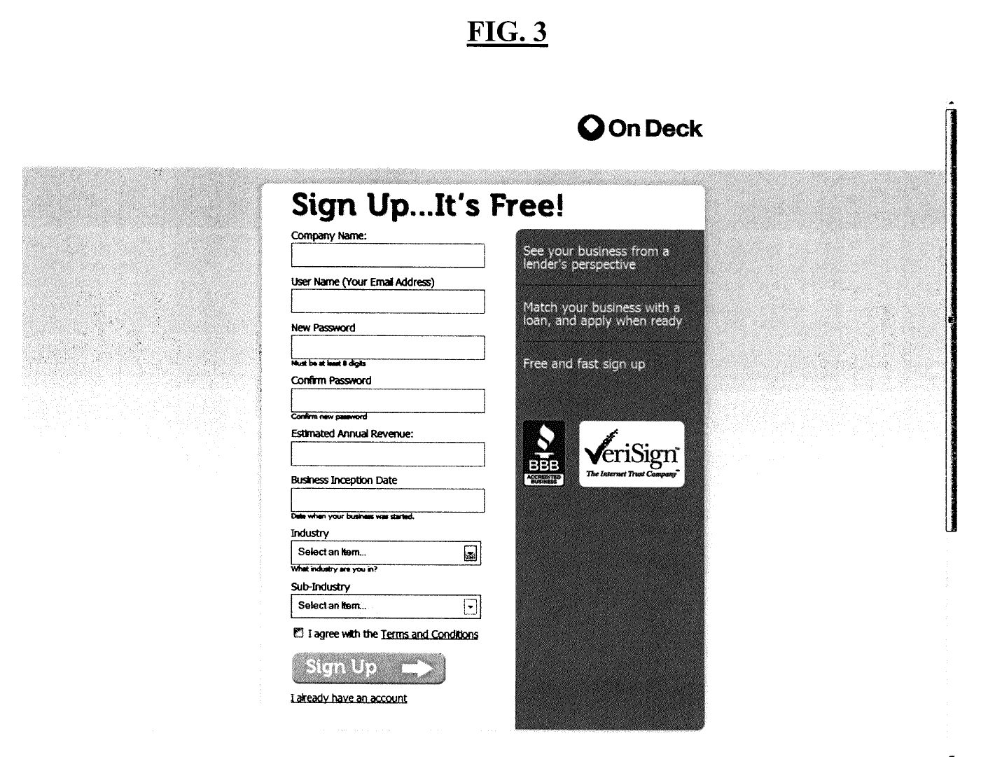

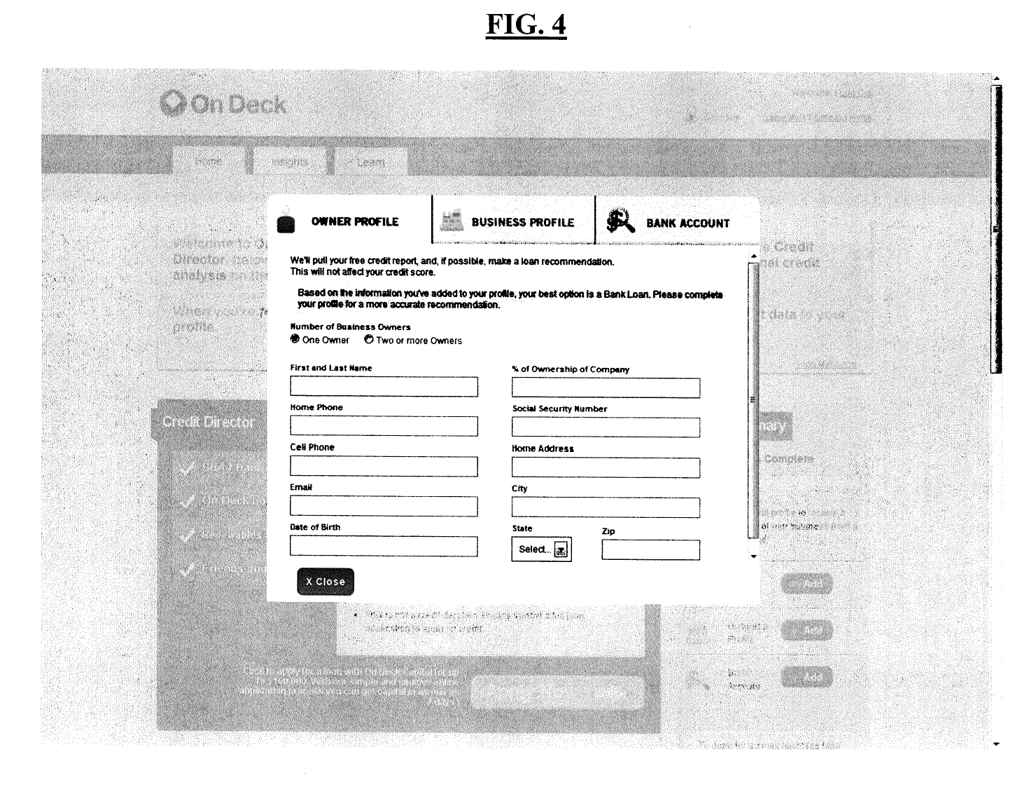

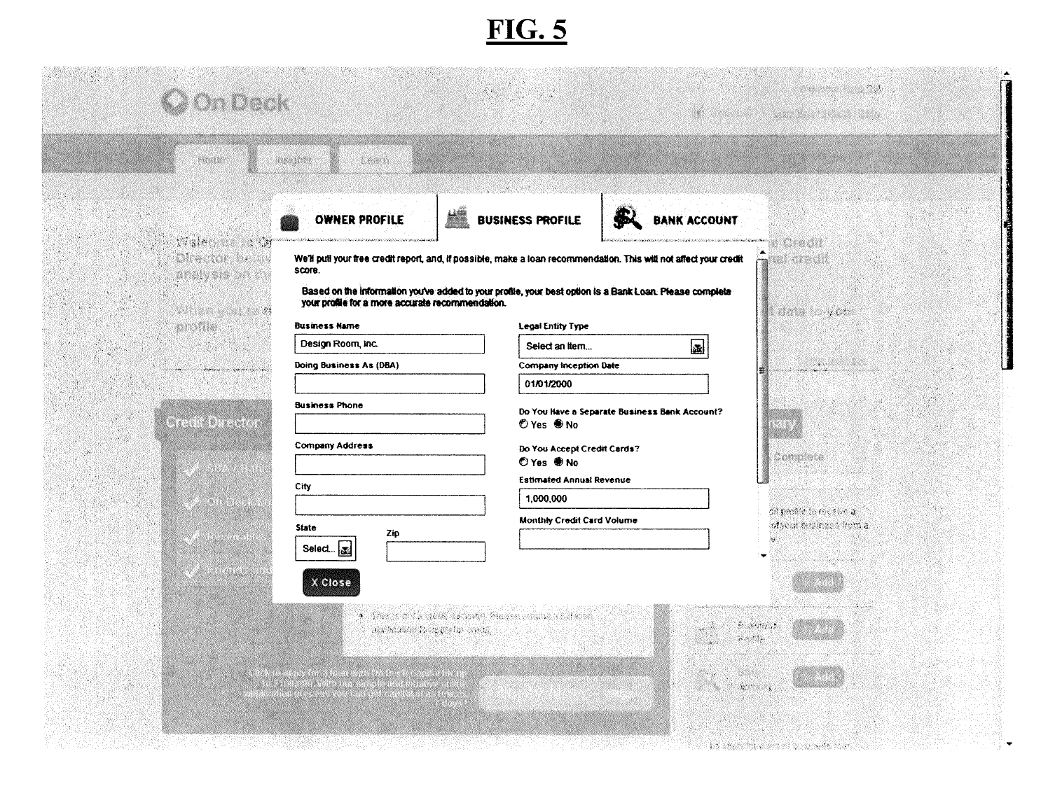

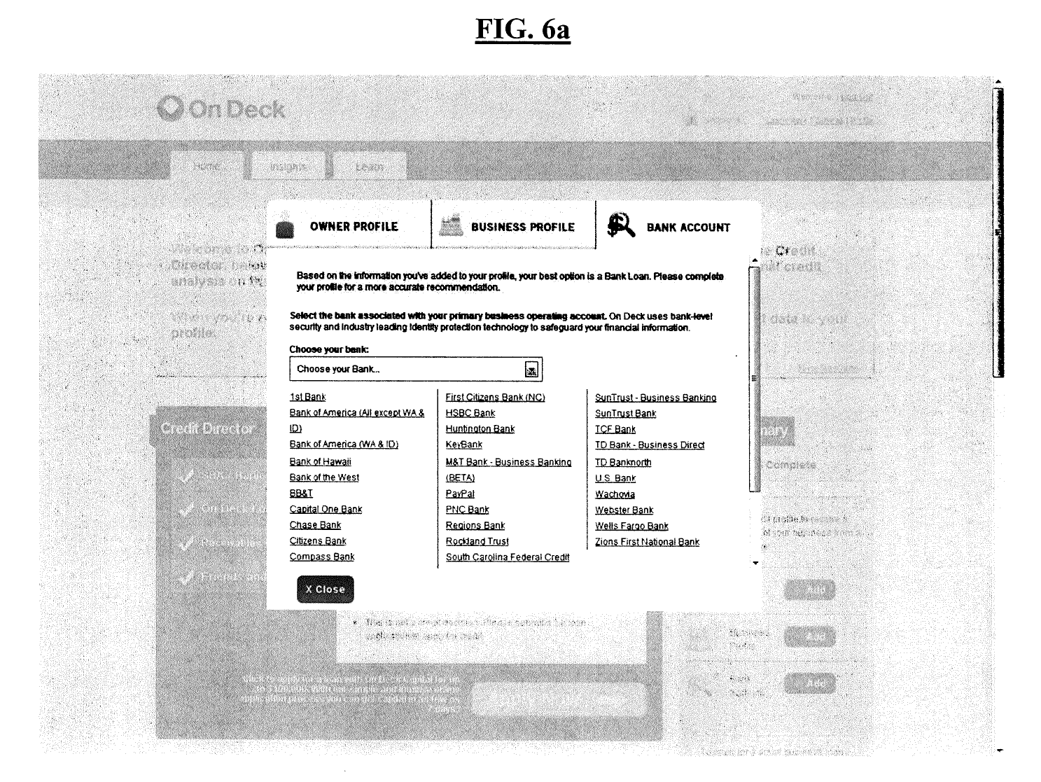

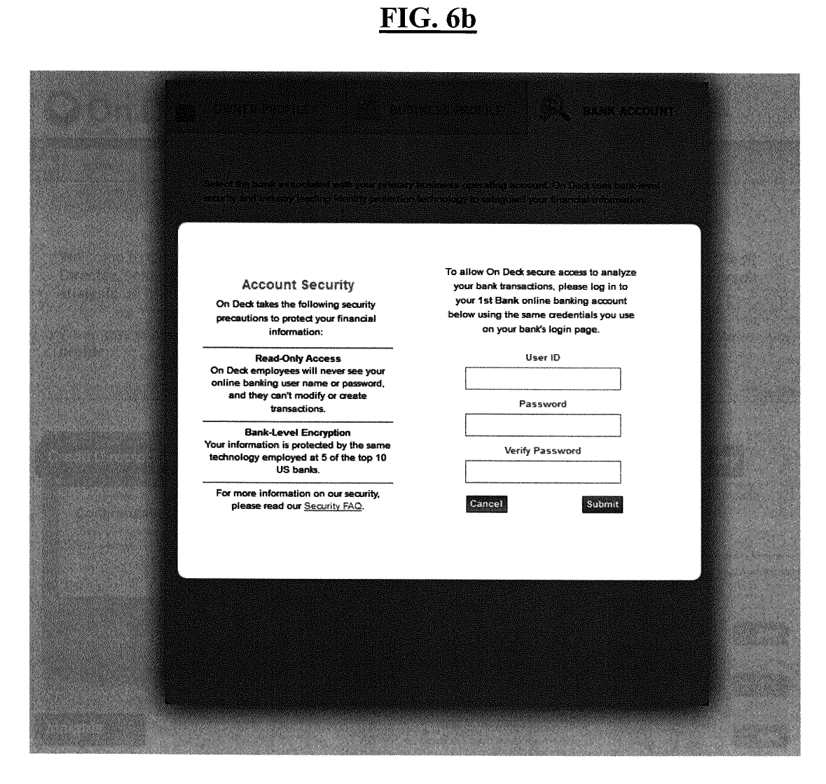

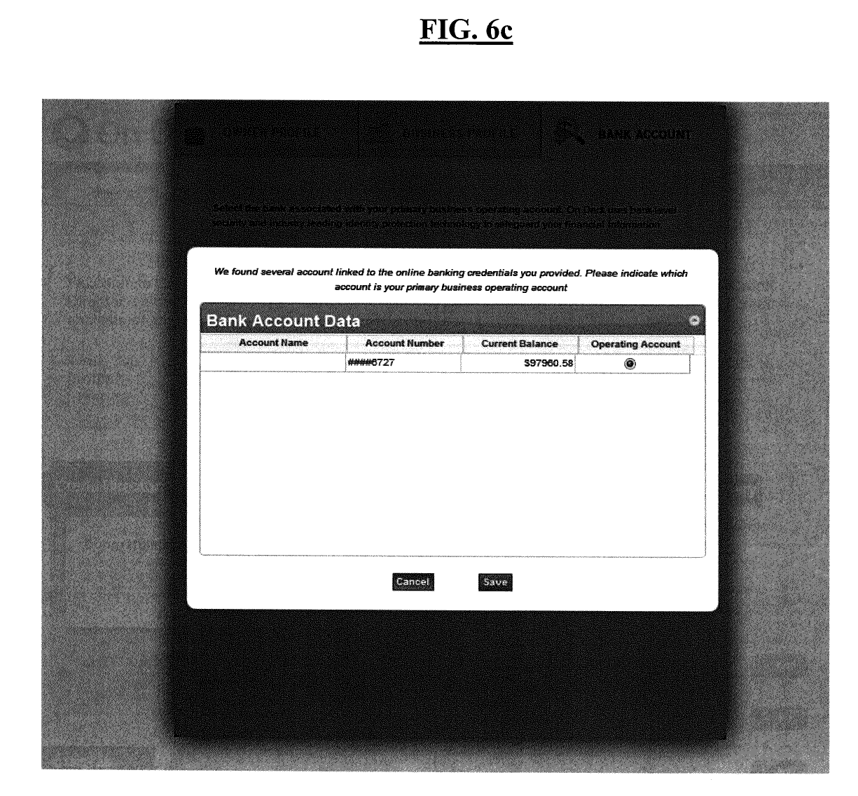

The first step in the method of the present invention involves obtaining loan application information from a borrower. This is represented by the “Apply Online” box in FIG. 1. The loan application information can be obtained by a borrower completing a loan application, for example, via a web application for a loan for a small business. The borrower may use the borrower's computing system to access the lender computing system through the Internet. In one embodiment, the borrower or customer navigates through a portal or customer landing page describing the lending options and benefits generally. FIG. 2 illustrates an example of such a landing page. After navigating through the optional landing page, the borrower is prompted to enter basic initial information about their contact information and business. Non-limiting examples include the company name, a user name and password for later access, estimated annual revenue, business inception date, and the industry and sub-industry that the business is involved in. FIG. 3 shows an example webpage of an initial information entry page for a borrower. Once this initial information is entered and transmitted to the system, the borrower may establish an account for future use. Further loan application or loan qualification information may also be required. Loan qualification information is information which will allow the system to gather information about the personal credit of the owner and business credit of the business. This information may include, for example, the social security number of the owner, or information about one or more bank accounts that the business uses to perform on-line banking. Information about the one or more bank account may also include credentials sufficient to allow the system to gain access to information such as account balance and banking statements. FIGS. 4, 5, and 6a display examples of webpages for entering and obtaining such loan application information, including owner information, business information, and bank account information. FIGS. 6b and 6c illustrate additional webpage examples for inputting additional information necessary to provide access to bank data.

Certain embodiments of the invention involve performing an application pre-filter based on the loan application information entered by the borrower. This is illustrated by the “Application Pre-Filter” box in FIG. 1. This pre-filter can be performed, for example, after the initial user and business data is entered by the borrower and received by the lender's computing system. The pre-filter could also be performed after more detailed information about the owner and business profile or banking information is entered by the borrower and received by the lender's computing system. The pre-filter can filter out borrowers based on certain basic screening criteria such as business years in operation, business cash flow or annual revenue, business location base, etc. The pre-filter can also involve a fraud check to ensure that the borrower's inquiry and information are genuine.

Once sufficient loan application information has been entered by the borrower, the system automatically queries data sources for detailed borrower information and records. Examples of such data sources such business credit (via API connection to the major bureaus), consumer credit (via API connection), firmographic data such as company revenue, industry and number of employees, for example, and bank data (via secure read-only connection to merchant's operating account) and social data, such as a business' online reviews, and the owner of the business' social network profile or reputation for example. These examples are shown in the boxes on the Platform Technology section of FIG. 1. This data aggregation preferably takes place over a network, such as the Internet. The aggregation can be performed by a data aggregation engine on or connected to the lenders computer system. This is represented by the “Data Aggregation Engine” box in FIG. 1.

The aggregated data can be used as an input to a rules engine underwriting algorithm on the computer system of the lender. This is displayed in the “Rule Engine Underwriting Algorithm” box of FIG. 1. An underwriting algorithm can be coded into a decision engine which automatically evaluates business profiles and outputs an underwriting decision. In certain preferred embodiments, the rules engine outputs a risk score. In some embodiments, the decision engine can also determine available loan terms and line assignments available to the borrower by using, for example, the borrower's cash flow data in conjunction with the underwriting output.

Embodiments of the invention can also include a business and merchant identity verification. This is embodied in the “Business and Merchant ID Verification” box in FIG. 1. In such a step, the borrower or business owner and the business entity, as well as the relationship between these entities is automatically vetted and verified using online and third party data sources. Fraud risks and unverifiable accounts can be flagged for manual follow up. An example of a method for verifying business and merchant identity involves generating and displaying on a borrower's computer system a series of identification questions based on the business, credit, and bank data that was entered by the borrower. If correct responses to the identification questions are received from the borrower's computing system, the identity has been verified.

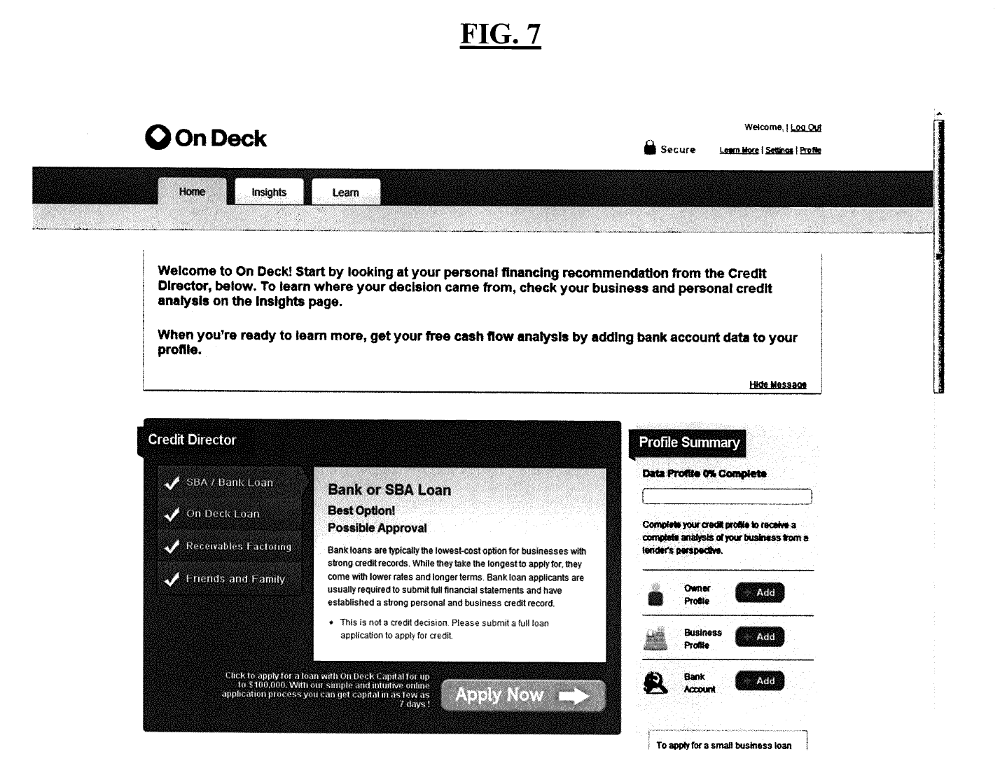

Based on the output of the rules engine, the lender's computing system can provide the borrower with financing recommendations and analysis. This is represented by the “Instant Online Approval” and “Instant Online Assignment” boxes in FIG. 1. This feedback may include eligibility for capital loans, business or personal credit analysis, or information regarding potential loans the borrower may choose from. FIG. 7 shows an example of a webpage that displays such feedback to a borrower. Based on the feedback, the borrower may apply for a new loan in real-time on-line. Once a borrower has decided to apply for a loan, the borrower may reconfirm information previously entered, or add new information. The borrower may also be asked to agree to appropriate terms and conditions.

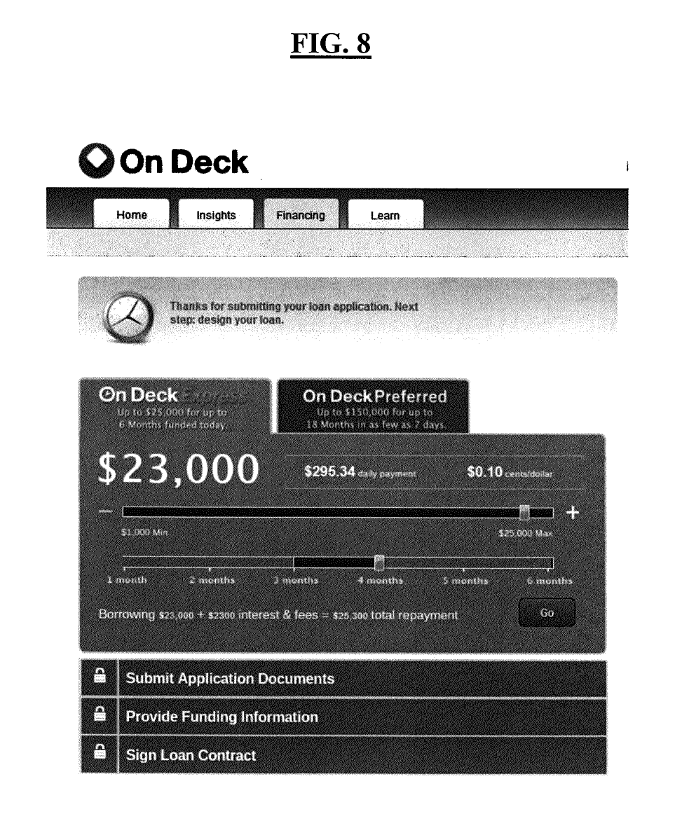

Once the loan application is submitted, for example to the lender via a network, the borrower may be given the option of designing the loan that they wish to receive. In one embodiment, the borrower utilizes a slider user interface on the borrower's computer system which allows them to customize, for example, the loan amount and loan term. FIG. 8 shows an example of what such a slider interface can look like as a webpage. As the borrower customizes the loan terms by selecting the loan amount and term, the system provides real-time feedback regarding repayment information, including total cost, as well as daily interest and fee breakdown. The “Online Term and Line Selection” box in FIG. 1 represents this step.

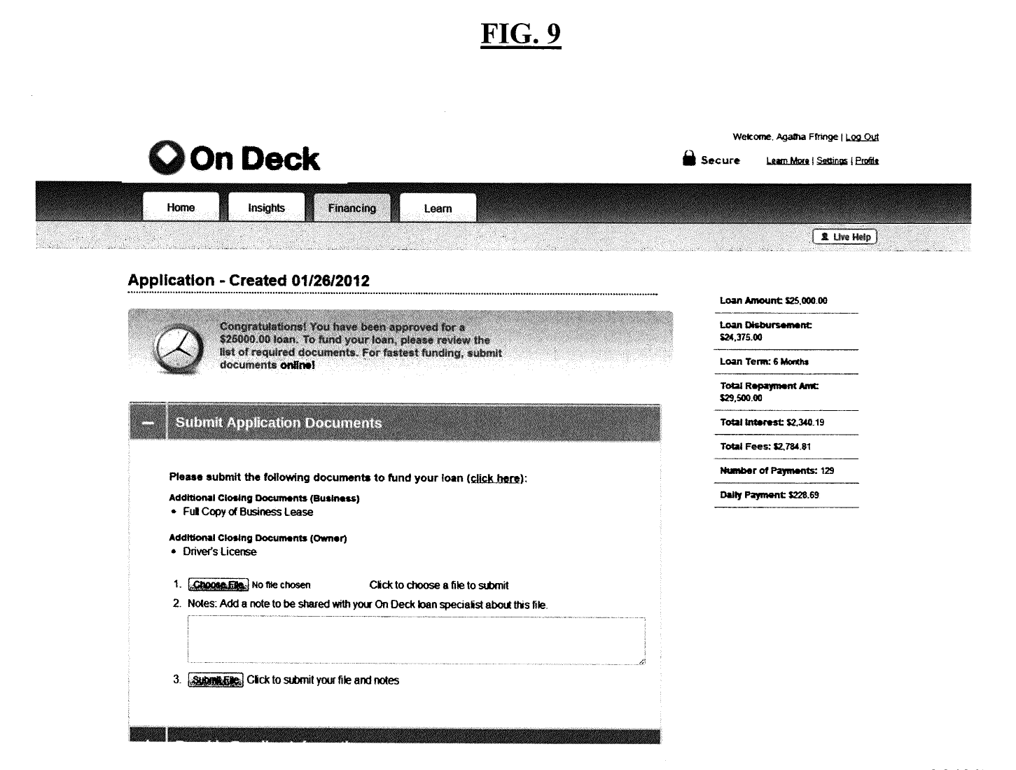

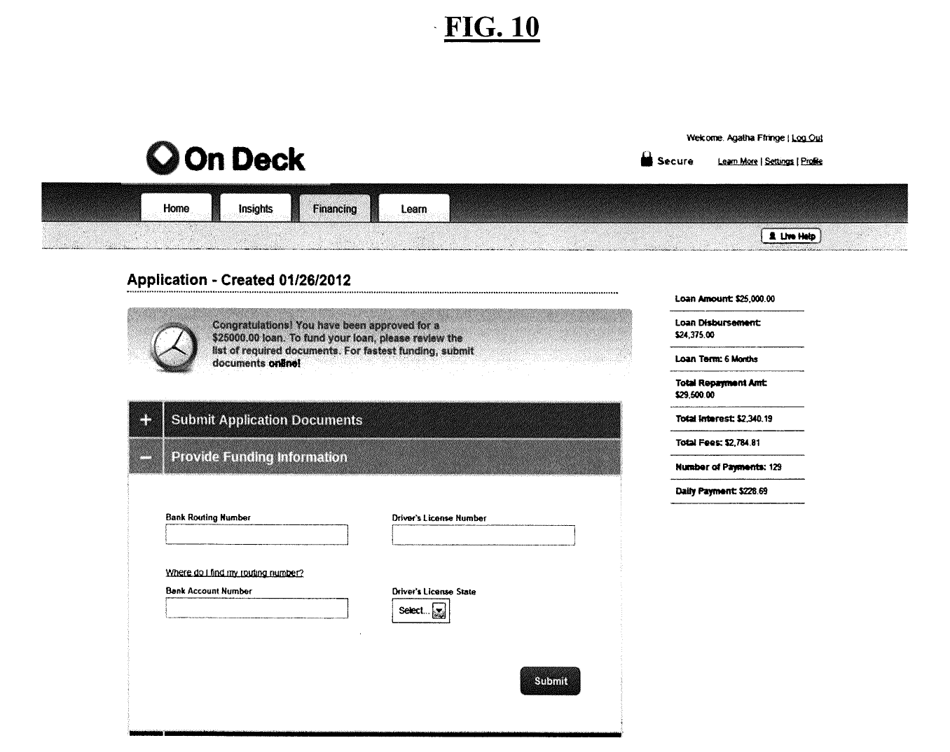

Once the borrower is approved for the loan and has chosen from the available terms, the borrower may be prompted by the system to electronically submit documents required for a loan closing. FIG. 9 displays an example of a webpage for the submission of loan closing documents. The system may also require the borrower to provide funding information, such as the borrower's operating bank account information for receiving the loan. An example of this interface is exhibited in FIG. 10. In some embodiments, the system also verifies the borrower's operating bank account prior to transfer. This is represented by the “Funding Account Validation” box on the Platform Technology section of FIG. 1.

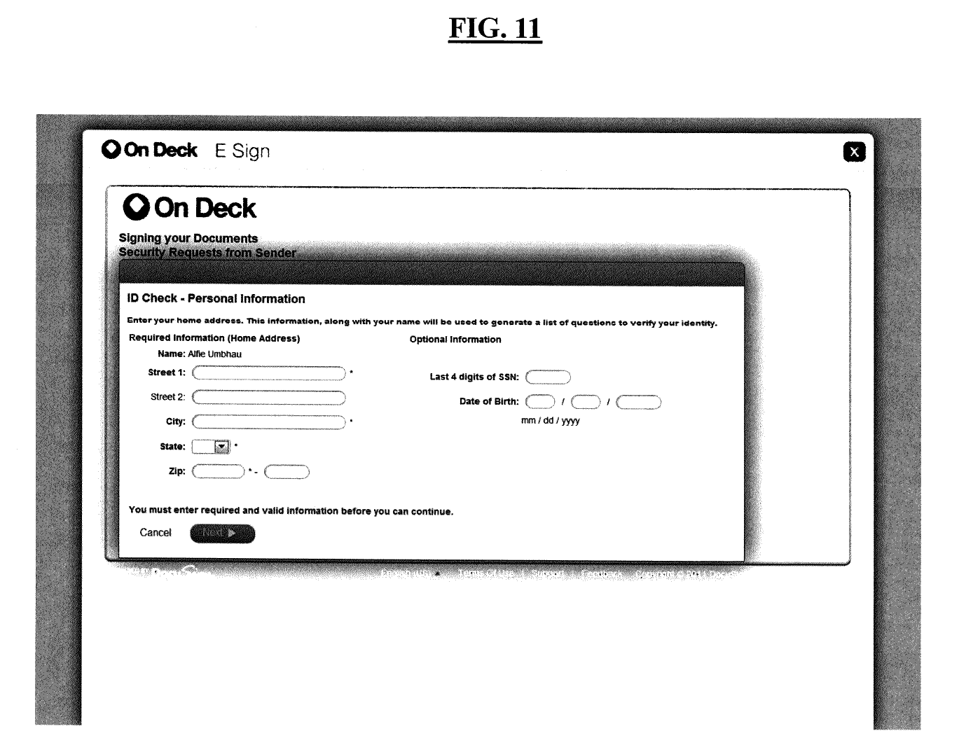

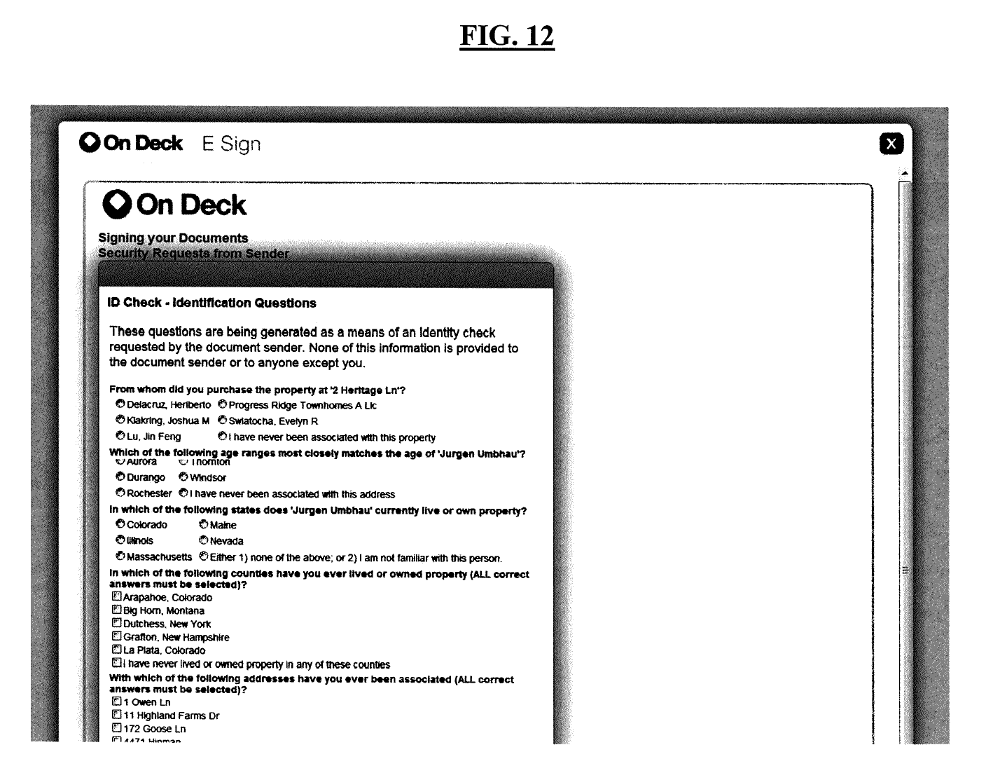

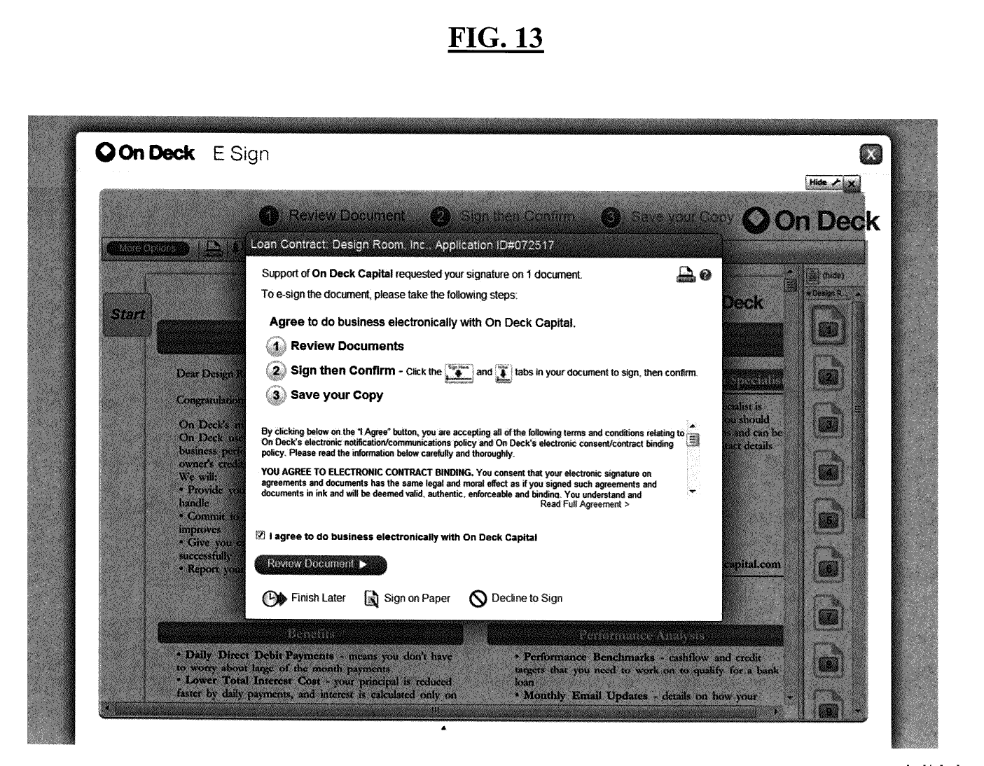

The system may also require the borrower to verify his identity and then sign a contract electronically, as the “Online Contract Signing” box of FIG. 1 indicates. The borrower's personal or business identity may be validated, for example, by answering particular questions culled from personal information available online but not easily accessible, such as “what street did you grow up on.” This document may be saved with an audit trail of actions and user identities. FIGS. 11 and 12 show exemplary webpages for verifying a borrower's identity. Once the contract is signed, for example via e-signature using a webpage as shown in FIG. 13, and the borrower has provided his bank account information, the loan will boarded into a loan servicing platform. The loan funds can be made available via an Automated Clearing House (“ACH”) and electronically transferred to the borrower's operating account often as soon as the next business day, as necessary. FIG. 1 indicates this step by the “Receipt of Funds via ACH” and “Automated Boarding & ACH” boxes.

The present invention also includes originating and servicing platform technology which allows the system to gather information and make lending decisions in real-time. After the relevant data is gathered, in real-time, an underwriting algorithm is coded into a decision engine, which automatically evaluates business profiles and outputs. The algorithm generates a risk score and an underwriting decision. If the decision is made to grant a loan to the borrower, the system will then verify the business and the merchant ID. The owner and business identity, as well as the relationship between the two, is automatically vetted and verified using online and third party data sources. Fraud risks and unverifiable accounts are flagged for manual follow-up. Finally, the user cash flow data in conjunction with the underwriting output is used to determine loan terms and line assignment.

As described above, the present invention uses data aggregation and electronic payment technology to evaluate the financial health of small businesses and to efficiently deliver capital to a market underserved by traditional bank loans. Through the described platform, millions of small businesses can obtain affordable loans to meet their daily operating and long term goals. The system looks deeper into the health of small businesses, focusing on the overall business performance, rather than the owner's personal credit history. In this way, the system provides a critically needed mechanism for commercial institutions to efficiently reach and serve the historically underserved small business market.

Although the present invention has been described with reference to preferred embodiments, workers skilled in the art will recognize that changes may be made in form and detail without departing from the spirit and scope of the invention.

We claim:

1. A method for transacting a monetary loan online for a business comprising:
receiving loan application information via a network from a borrower's computing system;
obtaining business, credit, and bank data for said borrower via a network using said loan application information;
making an underwriting decision and an available loan terms decision based on the business, credit and bank data;
displaying on said borrower's computing system via a network said underwriting decision and a list of said available loan terms;
obtaining selected loan terms and an electronic loan signature from said borrower's computing system via a network; and
providing loan funding according to said selected loan terms to said borrower via a network;
wherein each step is automated.

2. The process of claim 1, further comprising a step of determining a risk assessment score after obtaining business, credit, and bank data for said borrower.

3. The process of claim 1, further comprising filtering the loan application information for basic screening criteria prior to obtaining business, credit, and bank data for said borrower.

4. The process of claim 1, further comprising performing a fraud check prior to obtaining business, credit, and bank data for said borrower.

5. The process of claim 1, further comprising obtaining firmographic data and social data for said borrower via a network using said loan application information prior to making an underwriting decision.

6. The process of claim 5, further comprising making an underwriting decision and an available loan term based on the business, credit, bank, firmographic, and social data.

7. The process of claim 1, wherein the underwriting decision and the available loan term decision are made using a decision engine on a computer system.

8. The method of claim 2, wherein the risk assessment score is determined by a decision engine on a computer system.

9. The method of claim 1, further comprising verifying the borrower and business identity via a network prior to displaying on said borrower's computing system said underwriting decision and a list of said available loan terms.

10. The method of claim 9, wherein verifying the borrower and business identity comprises:
generating a series of identification questions based on said business, credit, and bank data;
displaying said identification questions on borrower's computing system; and
receiving correct responses to said identification questions from borrower's computing system.

11. The method of claim 1, wherein the loan funding is provided using Automated Clearing House.

12. The method of claim 11, wherein the loan funding is available to the borrower the next business day.

13. The method of claim 1, further comprising receiving the borrower's operating account information prior to providing loan funding.

14. The method of claim 13, further comprising verifying the borrower's operating account information prior to providing loan funding.

15. The method of claim 1, wherein the obtaining selected loan terms comprises:
obtaining a loan amount from said borrower's computer system;
displaying total loan cost, interest, and fees based on said loan amount; and
obtaining a loan duration from said borrower's computer system.

16. The method of claim 1, wherein said network is the Internet and said loan application information is received at a website on said Internet.

17. The method of claim 1, wherein the method is carried out in real time.
